(19) United States
(12) Patent Application Publication
(10) Pub. No.: US 2019/0223423 A1
(43) Pub. Date: Jul. 25, 2019

(54) Fish Pot Bait and Method for Fish Pot Fishing

(71) Applicant: Kvalvikbait AS, Tromsö (NO)

(72) Inventors: Svein Kvalvik, Tromsö (NO); Gustav Martinsen, Tromsö (NO); Sten Ivar Siikavuopio, Tromsö (NO); Svein Kristian Stormo, Tromsö (NO)

(21) Appl. No.: 16/309,606

(22) PCT Filed: Jun. 12, 2017
(86) PCT No.: PCT/NO2017/050154

§ 371 Date: Dec. 13, 2018

(30) Foreign Application Priority Data
Jun. 13, 2016 (NO) 20160997

(51) Int. Cl. A01K 97/04; A23K 50/80

(52) U.S. Cl. CPC A01K 97/045; A23K 50/80

(57) ABSTRACT

Fish pot bait and related method comprising attractant and at least one additional material that serves to determine the release rate of attractant to the environment. The at least one additional material serving to determine the release rate of attractant can be hydrated lime (Ca(OH)₂) as well as a further additive selected from the group consisting of balls of expanded clay, salt, seaweed meal and any ratio combination of salt, expended clay and seaweed meal.

### BACKGROUND

The disclosure relates to fish pot bait and an associated method for fish pot fishing.

Fish pot fishing is a widespread form of fishing commercially as well as in leisure fishing. There are fish pots adapted to various fish species and pots adapted shell fish. Common for all fish pots, baits are being used to capture the fish and shellfish. For most marine species, fresh baits in the form of herring, squid, etc. are used. Normally it is desirable to have the fish pots placed in the sea for several days. The natural baits deteriorate rapidly in the sea and eventually cease to attract fish and shellfish. Our studies show that baits from herring, squid, etc. leak out the odours in a timespan of about 2 days while the optimal pot fish bait should be effective for at least 4 days and preferably more than a week.

Fresh or frozen baits have a very short functional life in the fish pots. The baits deteriorate rapidly in the water and subsequently cease to attract fish and crabs. In addition, handling of fresh or frozen bait is not practical if cooling and freezing are required. Furthermore, it is not sustainable to use fish edible for human consumption as bait.

Tropical Areas

In tropical areas fish and shellfish often are captured with traps and fish pots in shallow water reefs and brackish water reefs. Fish pots are also used to capture deep-sea fish in these areas.

Most fish pots and traps used in the tropics are designed for fishing in the reefs, in rocky areas and on coarse sea bottom. The species being fished include squid and crustaceous animals as well as snappers, luvars, sea bass, parrotfish, surgeonfish, squirrelfish, angelfish, tropical mountain lobster and others. Fishing with fish pots is widespread in mangrove creeks and river mouth areas for different crabs (mud crabs, swimmer crabs, spanner crabs, etc.), adult shrimps (mud shrimps, yellow shrimps, etc.) and a number of offshore shrimps. Different types of squid are also captured in most tropical waters.

Subtropical and Tempered Areas

A selection of fish, squid and crustaceous animals are captured with traps and fish pots in these areas, which encompass everything from near-coast species like eel, terapons, wrasse, sea bass (barramundi), breams, croakers, and crabs like rock lobster and species living in deeper waters and snappers, trevallies, squid, hermit crabs, and shrimps.

Colder Waters

There is a lot of fish pot catching in the northern Atlantic Ocean, the English Channel and the northern Pacific Ocean even if not as widespread as in the warmer areas. Cod, cusk or ling are often caught with fish pots and there is substantial fishing for lobster, marine crayfish, whelk, and edible crab in the English Channel and outside the west coast of France. King crab, snow crab, lobster and shrimps are caught outside the coast of Alaska. Today, there is widespread fishing in the Barents Sea for king crab and snow crab. Along the coast of Norway edible crab, lobster, shrimps, ballan wrasse, and whelk are caught with fish pots. In addition, there is a desire to use large fish pots with long resident time to catch cod. For this kind of fishing, the it is desirable to use fish pots with a bait leakage for an extended period of 3 to 4 weeks.

In total there is a pot fish catch of fish and crabs exceeding 1.5 million tons per year.

Odours for Use in Fish Pots

The use of attractants for fishing and catching of fish and other marine species is well known in a number of contexts; attractants being substances that have an attracting influence on the marine specie in question—in combination with means that serve to determine the rate of release of attractant, so that it lasts for a certain time period.

This is also relevant for fish pot fishing to which the disclosed embodiments are directed.

In this context, it is known that baits for crustaceous animals, in particular lobster, which includes a pelletized carrier comprised by ingredients intended for extended useful lifetime in seawater. The pelletized carrier is mixed with attractants and a fish oil for prolonged release of the attractant. The pelletized carrier can comprise different kinds of meal, cf. U.S. Pat. No. 6,555,144 BI.

Furthermore, from US patent application No. 2013 0118 055 AI a lobster trap in the form of a “cake” is described, comprising a mixture of animal collagen, water, gelatine, gelling agent, fish meal, and fish oil, moulded and cured to a cylindrical cake. US patent application No 2011/0104 325 A describes an attractant for attracting fish, also comprising a binding matrix which contains a hydrated lime to control the release rate of attractant to the environment.

The publications CN 103875963 A and CN 103931909A concerns forage, which contain attractant and hydrated lime.

### SUMMARY

The disclosed embodiments provide an alternative to known means for control of release rate of attractants for fish pot baits, which means should be effective, inexpensive and not significantly affecting the aqueous environment.

More concrete, it is an objective to provide a fish pot bait which includes alternative means for controlling the release rate of attractant. Typical applications are for catching cod and other fish species, crabs and shell fish as well as species mentioned above in relation to tropical, subtropical and colder waters. The bait should also be well suited for catching lobster, snow crab and king crab.

It should be understood that what is here referred to as the environment is water, and more specifically seawater (saline water).

Use of hydrated lime and binder like expended clay as substance to control the release rate of attractant to the environment and thereby to attract crab, shell fish and fish, has proven very effective in practice. It is worth noticing that addition of hydrated lime to water has the effect of to some extent increasing the pH locally. In the amounts relevant to the use in relation to crab fishing, this effect will be minimal. However, this effect is generally desirable in many cases since aqueous environments have a tendency to become too acidic rather than too alkaline. In addition, a further additive is used, selected from the group consisting of balls of expanded clay, salt, seaweed meal and any combination of salt, expanded clay and seaweed meal.

As attractant in the disclosed embodiments, hydrolyzed bi-products or extracted odors from fish- or shellfish production is typically used. We also consider the use of bi-products from other food production relevant, like chicken production, cattle like e.g. casein, and vegetable sources like for example yeast and algae, micro-algae as well as macro-algae. In our tests we have used bi-products from shrimps and snow crabs.

Typically, the bait according to the disclosure comprises odors (attractant) adapted to different marine species and a carrier for the attractant. The attractant can comprise a mixture of odors recovered from marine resources, dry-slaked lime and a porous additive like e.g. expanded clay balls. The carrier, which in the present case is lime, is 100% environmentally friendly and is commonly largely used for pH adjustment of drinking water and industrial water treatment. Hydrated lime is an old known product, which has been used for disinfection for several hundred years due to its ability to increase the pH in water. In addition, it is preferred to add expanded clay. By adjusting the amount of expanded clay varying leakage rates of the odors from the bait is achieved and thereby the effective useful leakage time of the bait. This means that the bait can be adapted to different applications. Expanded clay is also 100% environmentally friendly and is therefore well suited for many applications. In our tests of the bait, expended clay is used as filler along with varying amounts of salt, fine grinded and coarse grinded.

In accordance with the inventive embodiments, a bait useful for pot fishing provides leakage of odors at a rate that can be controlled in accordance with the species of interest to catch. The bait is sustainable and does not cause any external effect other than a possible raise of pH, which, to the extent that is observable, normally is considered positive. By adding different odors, the bait will be effective for different species of fish, crabs, etc. When odors recovered by hydrolysis or extraction is combined with hydrated lime and carrier (like expanded clay), a paste is formed that can be molded, extruded or in other ways shaped to bait of adequate sizes. The paste is dried in air with or without heat.

Attractants that are used are most typically bi-products from the fishing industry. These are typically products which are not used for production or further refinement in any form. The disclosed embodiments, however, are not restricted to a particular type of attractant, but to a certain type of carrier for the attractant.

Social Value

An improved catching yield is obtained when using the present invention. The fish pot bait according to the present invention can be used for more than 7 days. This implies a more efficient fishing and the possibility of allowing fish pots stand for a week rather than 2-3 days. There is no need for cooling/freezing which reduces the costs and CO2 emissions. In the new bait, odors from bi-products from fishing production may be used.

The reduction in the use of fresh or frozen baits will be environmentally friendly, strengthen the fish stocks, and allow an effective use of scarce marine resources.

### BRIEF DESCRIPTION OF THE DRAWINGS

FIG. 1A shows change in bait composition over a test period of 14 days for a bait according to the present invention.

FIG. 1B shows leakage of attractant in the same period as FIG. 1A.

FIG. 2 shows effect on leakage rate of addition of different amounts of salt with different grind fineness.

FIG. 3 shows effect on leakage rate of different amounts of salt.

### DETAILED DESCRIPTION

In fish pot fishing, controlling the release of odors and the ability to adapt odors to different species of fish and crabs are the most important features in order to achieve efficient catch. The new fish pot bait opens for an entirely new way of controlling the release of odors to attract fish/crabs into fish pots and other traps. Use of bi-products from the fishing industry combined with hydrated lime and expanded clay provides a possibility of controlling release of odor. This is done by adjusting the amount of hydrated lime and expanded clay in the bait. During tests, we have experienced that the bait is effective for more than 3 weeks. According to the present invention, it is used in a weight ratio between attractant and hydrated lime in the range from 1:10 to 6:10, more preferred about 4:10.

Table 1 below shows the result from our test capture of cod. As can be seen, the fishing is improved with attractant from shrimps and snow crabs in comparison with herring as more commonly used for fish pot fishing.

TABLE 1
Test catch

| | | | | | Number |
|---|---|---|---|---|---|
| | Sums of | Sums of | Sums of | Sums of | of fish |
| Row labels | cod | saithe | other | Total | pots |
| Divided herring | 38 | 27 | 2 | 67 | 18 |
| (Known technique) | | | | | |
| Shrimp attractant | 49 | 38 | 8 | 95 | 18 |
| (present invention) | | | | | |
| Snow crab attractant | 78 | 41 | 7 | 126 | 18 |
| (present invention) | | | | | |
| Total sum | 165 | 106 | 17 | 288 | 54 |

Experimentally: Leakage of Attractant

Leakage Test 1

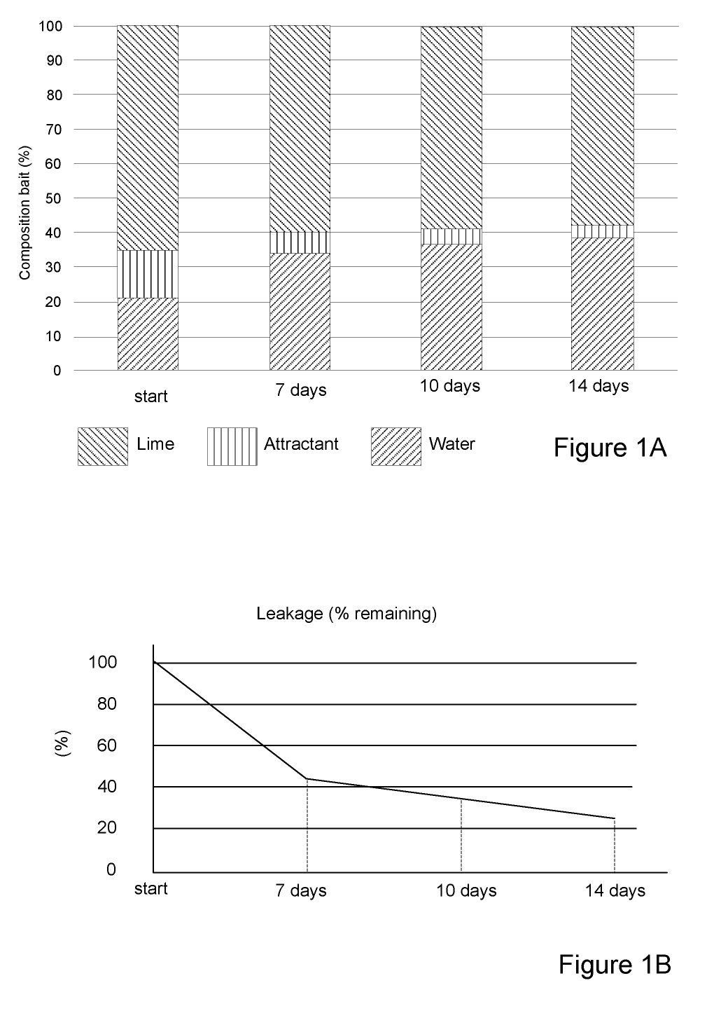

The results of studies of fishing in September 2015 at a depth of 70 m in seawater is shown in FIGS. 1A and 1B. These show that there is good relation between leakage of attractant and dissolution of the lime in the water for a period of 14 days.

Leakage Test 2

5 portions of bait paste (lime+hydrolysate) of 30 g were weighed out and salt was added to four of these. 15 and 30g (33 and 50%) salt was used of both coarse and fine grinded salt, i.e. 4 different compositions. The fine grinded salt was sieved from the coarse salt and was in practice identical to the coarse salt with the exception of the grain size.

A portion of 30 g bait paste was additionally mixed in the same concentration as for the samples described above (about 1.8 L saline water) to find final concentration, i.e. the value the solution would theoretically reach when everything had leaked out. Sampling was then performed in a timespan of near 100 days.

Table 2 below shows composition and time for each of the samples to reach 50% leakage.

TABLE 2
Leakage test with salt

| | Base paste (lime + | Coarse salt | Fine grinded | 50% leakage |
|---|---|---|---|---|
| | attractant (g) | (g/%*) | salt (g/%*) | (hours) |
| 1 | 30 (control) | 0/0 | 0/0 | 58 |
| 2 | 30 | 15/33 | 0/0 | 30 |
| 3 | 30 | 30/50 | 0/0 | 28 |
| 4 | 30 | 0/0 | 15/33 | 49 |
| 5 | 30 | 0/0 | 30/50 | 50 |

*% of total weight after addition of salt

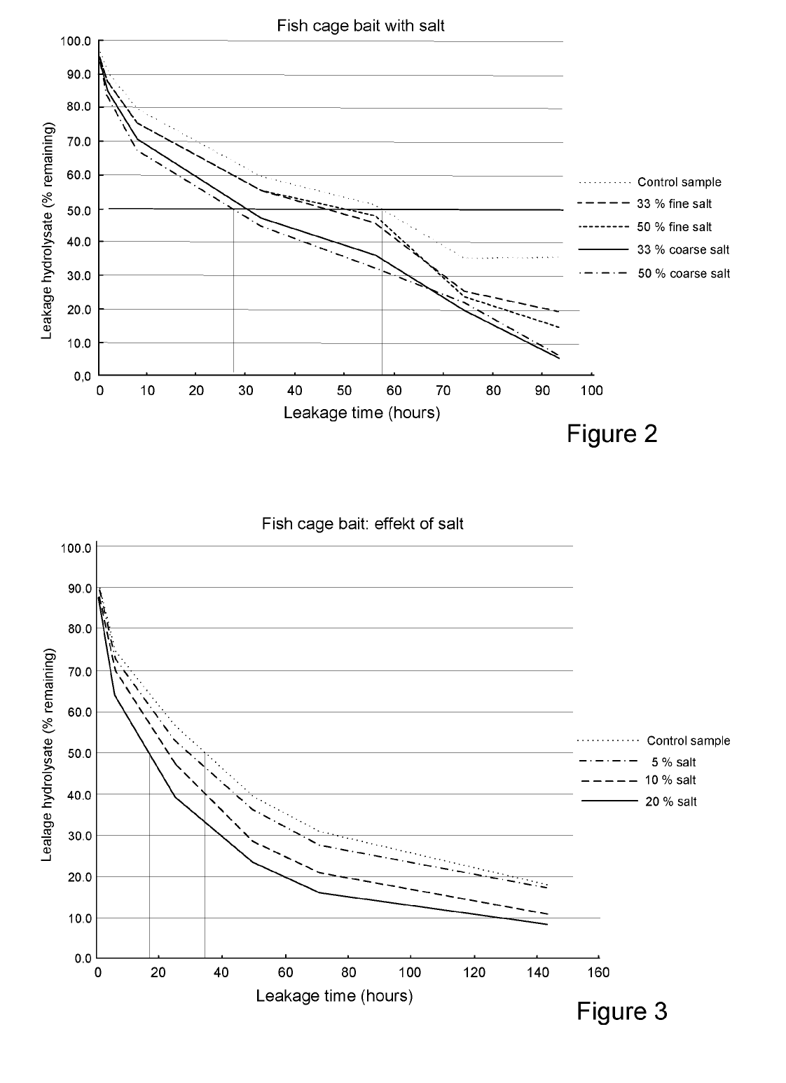

FIG. 2 shows graphically the progress of leakage for a period of 100 hours (4 days).

As shown, the leakage is influenced by the presence of salt and more influenced by coarse salt than by fine grinded salt. Using coarse salt, the leakage rate was nearly doubled to 50% leakage. The leakage rate, however, was not influenced much by the concentration of the salt within the tested concentration range.

The texture of the control sample was significantly different from the other samples. It was still quite hard/ductile. The other samples felt more porous/soft. No grains of salt.

What is not disclosed by the tables or the figures, but which was observed visually, was that a visible coating of lime, possibly carbonate, was reduced when salt was added to the samples.

Leakage Test 3

The leakage test was repeated with more and lower concentration of salt, as shown in FIG. 3.

At these lower concentrations a clear relation between concentration of salt and rate of leakage was observed. This means that it is possible to tailor the bait for a specific purpose, dependent upon whether it is desirable that the leakage be comparatively rapid, e.g. lasting for a period of a few days, such as 4 days, or if it is desirable that it lasts for e.g. at least 8 days or at least 14 days. While there was little difference observed between 33% and 50% salt, a significant increase in leakage rate was observed in the range from 5% to 20%, but also a not insignificant increase already from 0% to 5%.

Without limiting the scope of the invention to a certain theory, it is believed that the presence of salt, which is soluble in water, contributes to forming channels in the block or matrix of the bait so that its effective surface is increased and thereby the leakage rate to the environment. Addition of salt in a desired amount thus represent a variant of the inventive concepts disclosed herein.

In total, the results show that a combination of attractant with Ca(OH)₂ implies an extension of the functional leakage time of the bait, in that the attractant is released more slowly to the environment. Adding additives in the form of salt, seaweed meal or balls of expanded clay, or any combination thereof moderates this effect. The additional additive is used in an amount of up to 60% by weight of the total weight of the fish pot bait, water included. In some embodiments the mentioned additive may be used in an amount of 2-40% by weight of the total weight of the bait, water included. In other embodiments, additive in the form of salt can be used in the range from 5 to 60% by weight of the total weight of the bait, water included. The salt typically is NaCl, KCl or a combination thereof.

The bait is produced by combining attractant and dry-slaked lime in the ratio 45/50 depending upon the dry weight percentage of the attractant. Thereafter salt is added so that leakage time can be controlled by the amount added. Salt has the property of being dissolved by water and forming channels in the bait, something which allows attractant to leak out more rapidly. The dry substance content of the attractant is typically between 30 and 60%, more preferred between 40 and 50%, particularly preferred about 45%.

Where it is not a requirement that salt is added, expanded clay or seaweed meal can be added to achieve the same effect. The clay will open the bait to increased leakage rate.

Practical tests with snow crabs in Kaarvika show that snow crab and sea urchin are attracted by seaweed. Seaweeed contains, in other words, low molecular substances which have an attractive effect on shellfish. Seaweed and sea tangle contain important nutrients for sea urchin, edible crab, lobster, king crab and snow crab, which explains why these animals are attracted to seaweed and sea tangle.

Further extension of the leakage time can be achieved by the use of a coating of a PVA polymer foil of desired thickness.

The bait can be used as is in standard bait bags or in PVA plastic bags used as bait bags. These are bags with holes to ensure circulation with the surrounding water, that being micro-holes or larger holes.

1-11. (canceled)

12. A fish pot bait for use in an environment, comprising:
an attractant; and
materials that impact a rate at which the attractant is released to the environment, wherein
the materials that impact a rate at which the attractant is released to the environment comprises hydrated lime (Ca(OH)₂) and one or more of another additive selected from the group consisting of expanded clay, salt and seaweed meal.

13. The fish pot bait of claim 12, wherein the attractant is present with a dry substance content between 30% and 60%.

14. The fish pot bait of claim 13, wherein the attractant is present with a dry substance contend between 40% and 50%.

15. The fish pot bait of claim 12, wherein the ratio of attractant to hydrated lime is within a range of 1:10 to 6:10 by weight.

16. The fish pot bait of claim 13, wherein the ratio of attractant to hydrated lime is within a range of 1:10 to 6:10 by weight.

17. The fish pot bait of claim 15, wherein the ratio of attractant to hydrated lime is approximately 4:10.

18. The fish pot bait of claim 12, wherein the further additive is present in an amount of up to 60% by weight of the total weight of the fish pot bait.

19. The fish pot bait of claim 18, wherein the further additive is present in an amount within the range of 2-40% by weight of the total weight of the fish pot bait.

20. The fish pot bait of claim 12, wherein an amount of additive in the form of salt is present in the range 5-60% by weight of the total weight of the fish pot bait.

21. The fish pot bait of claim 12, wherein the further additive is a salt selected from the group consisting of NaCl, KCl and a mixture thereof.

22. The fish pot bait of claim 12, further comprising an enveloping foil of polyvinyl-alcohol.

23. The fish pot bait of claim 22, wherein the enveloping foil has holes.

24. The fish pot bait of claim 23, wherein the holes are micro-holes.

25. The fish pot bait of claim 17, further comprising an enveloping foil of polyvinyl-alcohol.

26. The fish pot bait of claim 19, further comprising an enveloping foil of polyvinyl-alcohol.

27. The fish pot bait of claim 21, further comprising an enveloping foil of polyvinyl-alcohol.

28. The fish pot bait of claim 12, wherein the attractant is released to the environment at a rate such that the fish pot bait has an effective lifetime of at least 14 days.

29. A method for crab fishing using fish pots with fish pot bait in an environment, comprising
providing an attractant; and
providing materials that impact a rate at which the attractant is released to the environment;
providing an additive selected from the group consisting of balls of expanded clay, salt, seaweed meal and combinations thereof to form the fish pot bait; and
placing the fish pot bait in the environment, wherein
the materials that impact a rate at which the attractant is released to the environment comprises calcium dihydroxide, and
the rate of dissolution of calcium dihydroxide in seawater impacts the rate at which the attractant is released to the environment.

30. The method of claim 29, wherein the fish pot bait is placed in a coating of polyvinyl-alcohol for prolonged time period for delayed start of release of attractant to the environment.

31. The method of claim 30, wherein the coating of polyvinyl-alcohol is perforated.
